(19) United States
(12) Patent Application Publication
(10) Pub. No.: US 2002/0111823 A1
(43) Pub. Date: Aug. 15, 2002

(54) Quality management method

(76) Inventor: Thomas Heptner, Muenchen (DE)

Correspondence Address: BELL, BOYD & LLOYD, LLC, P. O. BOX 1135, CHICAGO, IL, 60690-1135, US

(21) Appl. No.: 09/968,080

(22) Filed: Oct. 1, 2001

(30) Foreign Application Priority Data
Sep. 29, 2000 (EP) 00121480.8

(51) Int. Cl. G06F 17/60

(52) U.S. Cl. 705/1

(57) ABSTRACT

A quality management method, implemented by a data processing method, for administering the formal component of quality assurance and for collecting and evaluating cyclic and isolated metrics in arbitrary projects in a computer network having at least one server and precisely one database, having client applications for at least one quality assurance client and project participant clients having separate access rights which are respectively obtained via a client password.

### BACKGROUND OF THE INVENTION

The present invention relates to a method for the quality management of at least one project in a computer network.

To date, review and release methods have been handled either electronically on a platform and location basis or using forms on paper and/or Interleaf or Word documents. This was very time consuming. In the software projects, forms for review invitations, review records and releases were filled in using Interleaf and were distributed by internal mail. After e-mail had been provided throughout many companies, the forms were distributed as attachments to the e-mails and were, thus, likewise physically duplicated. These forms contained a great deal of redundant information, and filling them in was very susceptible to error. The distribution list in the e-mail often did not correspond to the current distribution list in the form. In addition, it was always necessary to indicate a location and department in addition to the name. Names, paths and versions of the files needed to be typed into the form. These were, thus, physically present both in the configuration management and in the forms. This method was very complex, as a result of which meant that a review cost the organizer up to three hours of purely formal effort. In addition, the method was limited by the fact that the recipients of the forms needed to have the appropriate word processing system installed in order to be able to open, read and print them. Providing the e-mails with attachments made them very long and encumbered the network on which they were sent. From the point of view of quality assurance, the statistics, for example the error and time statistics, needed to be transferred manually to Excel tables from the forms sent.

In a statistics collection process, numbers of error and test cases are recorded. To this end, quality assurance previously sent weekly reminder e-mails to the project collaborators in order to indicate to each project collaborator that, during the test phases, he/she needed to send his/her test statistics to quality assurance, sorted and grouped on the basis of milestones and objects or functional units. The e-mails were not sent automatically. In addition, the reminder e-mail proposed an outline which was frequently ignored. In this case too, the data sent needed to be transferred manually to the appropriate Excel tables from the response e-mails.

It is, therefore, an object of the present invention to provide a method which permits quality management involving little time and financial input.

### SUMMARY OF THE INVENTION

Accordingly, the data processing method of the present method is a quality management tool (QMT) for administering the formal components of a quality management process. The inventive method achieves, in contrast with the methods used previously, a great time and cost saving and a standard quality framework for all projects. This method can be used to cover a large number of projects and can be adjusted to suit large and small projects. It enables standard and comparable measured values to be recorded in a system. The inventive method is independent of operating system, thus overcoming interfaces between media. In contrast with the processes previously carried out in paper form, the administration involved for the formal component is significantly reduced so as to achieve a cost and time saving of up to 95%. All the data are available online, wherein there is no need for data to be stored locally on data media for security reasons; instead, this is done only in the single database. As such, the local storage capacities of the individual project participants are encumbered to a lesser extent. This also ensures that all data have their validity in the respective process. Entry of a password ensures that only authorized persons gain access to the quality management method.

It is advantageous if the method is used for planning, carrying out, tracking and/or checking quality assurance measures in arbitrary projects. Quality assurance measures are understood to be, by way of example, the following types of checks when completing actions in projects (milestones): intensive inspection, walkthrough review, test milestone declaration and milestone declaration. A milestone refers to completion of an action in a project which is subdivided into different actions. These are monitoring points which need to be reached and completed with a particular check. Examples of such actions are: design, code and check. For the important activities, the project participants are advantageously guided through a process, not all of whose details need be known to them. The acceptance is very high as a result of guidance in the process since it is comprehensible to and requires very little effort from the project participants and is regulated in the same way for all.

It is also advantageous if the method is used for planning, collecting, monitoring and/or evaluating isolated and/or cyclic project and process metrics. This allows for, even for the important processes, the same advantages in terms of project and process metrics to be achieved as set out above in relation to the quality assurance measures.

It is also advantageous if the inputs which are to be made by the project participant have been minimized, known data which have already been input once are offered for selection and/or proposed values are shown to the user and/or can be altered, the user guidance is rigorous and the project participant is able to alter only those data which may be modified without the consent of the quality representative. This advantageously implements an idea for a learning system. Only data which already have been input once and have been confirmed at least once in an input mask of QMT Admin are shown to the user, and he/she is able to alter them given the necessary authorization. For this reason, project collaborators who are under pressure with respect to time and performance regard this method as a tool which alienates their work, which likewise allows its acceptance to be increased. The result of this is that the inhibition threshold at having reviews registered and tracked formally as well is significantly lowered. This results in a considerable increase in the efficiency of the entire quality management process per se.

It is also advantageous if numerous project and/or metric overviews can be produced online in parameterizable form. The overviews include, by way of example, timetables, personnel utilization, milestone, project and milestone completion reports in the shape of forms and also metric evaluations and reports. These are processed graphically and are provided with bar charts, for example. They can be produced online by the respective authorized party. In addition, data can be exported to other methods, such as to Excel. The advantage of numerous evaluation options makes the QMT of great interest to the project manager. Quality assurance has support in all actions of formal quality assurance, and a very great rationalization effect. A much lower time involvement allows for more projects to be processed.

It is also advantageous if e-mails which are automatically produced by a state-controlled server and are used to instigate particular actions in the process are equipped with a direct link to an appropriate recording or input mask and are sent by the state-controlled server in HTML or ASCII format with no attachment. The e-mails include, by way of example, status, invitation, request, reminder and default e-mails. In this case, the QMT server produces direct links to the masks which are to be filled in in the QMT client so that the project collaborator can input his information directly after clicking on the link. The project collaborator can also get to these masks using the entry selection of the QMT client should he/she have mislaid the e-mail. This also results in the project participants being guided through a process, all of whose details need not be known to them, guidance in the process significantly increasing the acceptance on the part of the project participants.

It is also advantageous if the method is fully automated but consciously reserves a gap at the end of the automation chain in which the quality assurer(s)(QA) is/are able to check the quality of the product, the process implementation and/or the metrics. The effect advantageously achieved by the gap is that more security is obtained about the quality of the product and the life of the process by the project participants, and a reliable basis for evaluating the metrics is obtained. These are then the same and comparable in character even beyond the boundaries of the project. The life of the process is understood as compliance with prescribed process stipulations. In addition, the gap increases the acceptance for the quality assurance measures due to the conscious addressing of the results from reviews and checks, and the process can be continually improved. Furthermore, more acceptance of the management with regard to the metrics is achieved, the metrics then also being able to be used as the basis for decisions for supporting measures within the projects and for overall process control. Ultimately, it is also possible to make more reliable statements about product quality. This use simultaneously results in further growth, as already from a number of aforementioned advantageous developments of the present invention, in the project collaborators' acceptance of statistical recording.

It is also advantageous if the quality assurer (QA) is able to produce, change and delete all data and to initiate or stop actions in the process at any time in the process. This ensures a smooth flow within the process. If, for example in the case of an invitation, a typing error is made in an e-mail address for an involved party, and the e-mail is returned as undeliverable, the quality assurer can send another invitation by e-mail and can use the proper, corrected e-mail address for this.

It is also advantageous if the data processing method gives online help, and/or an online process description is available. The effect advantageously achieved by this is that the project collaborators have the assistance directly in the tool which is currently being used whereby they receive adequate help at any time for the currently encountered problems. The whole method becomes simpler to handle and, thus, safer. In addition, the process description allows all the project collaborators to become familiar with the process more easily.

Additional features and advantages of the present invention are described in, and will be apparent from, the following detailed description of the invention and the figures.

### BRIEF DESCRIPTION OF THE FIGURES

FIG. 1 shows a flowchart for a document control review.

FIG. 2 shows a flowchart for recording cyclic metrics.

FIGS. 3-10 show a time sequence of masks encountered for an invitation to a review.

### DETAILED DESCRIPTION OF THE INVENTION

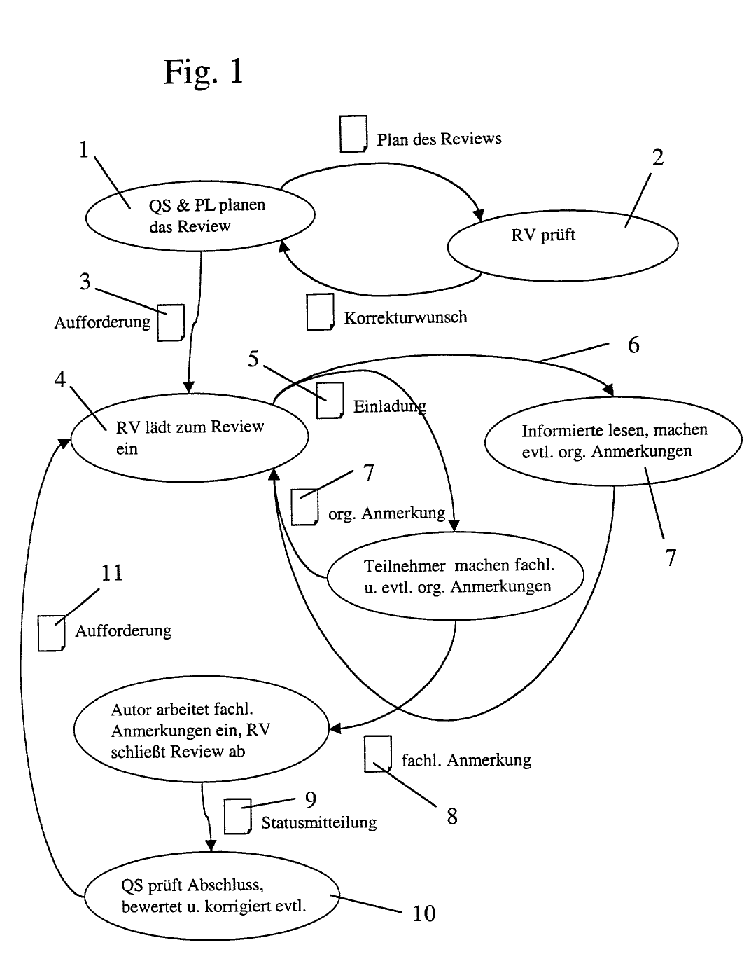

FIG. 1 shows how a quality assurer QA plans a review with a project manager PM in a planning phase 1. To this end, the quality assurer QA creates a new project in QMT Admin, the administration component of the QMT, which is only accessible to the quality assurer QA and permits all the administration work. In QMT Admin, all the collaborators, functional units/objects and all milestones which are to be reached for this project are input, the persons responsible for functional units and objects are assigned, and it is determined which milestones need to be completed by which functional unit/objects using what type of quality assurance measure, and the person responsible for the measure is determined. In addition, deadlines can be indicated, such as AFI (Available for Inspection—the time at which there is an invitation to implement the quality assurance measure), review deadline (the time for implementing the quality assurance measures) and IUS (Inspected, Updated and Stored —the time at which the subject under review is released and the milestone is reached). Furthermore, the planned participants can be indicated. In addition, unspecified text can be stated, for example containing further details about the rough planning of the review.

The quality assurer QA may at any time change the indicated plan values, cancel reviews or delete them from the database. The QMT server sends the plan of the review to the person responsible for the review RV. This person checks 2 the plan and, if appropriate, returns correction requests to the quality assurer QA.

At the time of the invitation 4 (AFI) to the review by the person responsible for the review RV, the QMT server sends to the person responsible for the review RV a request 3 in the form of an e-mail as an invitation to implement the quality assurance measure using a direct link to the mask for inputting the invitation in the QMT client, the user interface for the project collaborators. The project collaborator can also get to this mask using the entry selection of the QMT client, should he/she have mislaid the e-mail.

For the invitation, the name of the person responsible for the review RV, the authors, the participants and the deadlines (including IUS) can be corrected. The plan data are shown to the user, or data which already have been input once are offered for selection. The persons to be instructed, the informed persons, the place for the review meeting, a stamp on the documents/sources/papers to be reviewed in the configuration management, which previously have been checked in and have been stamped using a command line tool, and an unspecified text comment in which the technical responsibilities and roles in the review process of the individual review participants and the more accurate timetable can be entered.

The informed persons are sent a notification 6 by the QMT server, and the participants are sent an invitation 5 in the form of an e-mail containing all the data required for the review and a link to the mask for inputting the technical comments in the QMT client. The comments can be submitted in the unspecified text field. Complexity and error metrics are requested in obligatory fields. The project collaborator can also get to this mask using the entry selection of the QMT client, should he/she have mislaid the e-mail. One day before the submission deadline for comments relating to a Document Control Review, the QMT server automatically addresses a default e-mail of the same type to a defaulting participant.

Both the informed persons and the participants may at any time during implementation of a quality assurance measure submit comments relating to the subject under review. Between the planning and release of a review, organizational observations 7 relating to review planning, flow or anything else additionally may be submitted. These are addressed only to quality assurers QA or else additionally to all participants and to the persons responsible for the review RV (shown in this case). The technical observations 8 by the participants are sent to the author. The author incorporates the technical observations. Once the invitation has been produced, the person responsible for the review RV receives an e-mail from the QMT server with a direct link to the mask in the QMT client for inputting the Release Note used to complete a review. The person responsible for the review RV can also get to this mask using the entry selection of the QMT client, should he/she have mislaid the e-mail.

Finally, the revised documents/sources/papers are checked into the configuration management, and a command line tool is used to provide them with the appropriate release status and with a stamp which is entered into the completion mask in the QMT client. In addition, an unspecified text for indicating conditions/restrictions/particular features can be written. The release date is indicated and quantity, complexity and error metrics are requested.

After the release message has been sent, a status notification 9 is delivered to the quality assurer QA by the QMT server in the form of an e-mail containing a direct link to the mask in the QMT client for checking 10 the Release Note. The quality assurer QA can also get to this mask using the entry selection of the QMT client, should he/she have mislaid the e-mail.

At this point, the quality assurer QA can test the results of the quality assurance measure, can conduct interviews with the person responsible for the review RV and/or with the participants and, by way of example, can revise the metric values and/or the release texts and can release the review, declare the milestone or prompt a follow-up review.

The follow-up review is initiated by a request 11 to the person responsible for the review RV. The person responsible for the review RV then issues another invitation to the review, as described above in the step “invitation 4”. This is followed by the steps outlined above until a release is issued by the quality assurer QA.

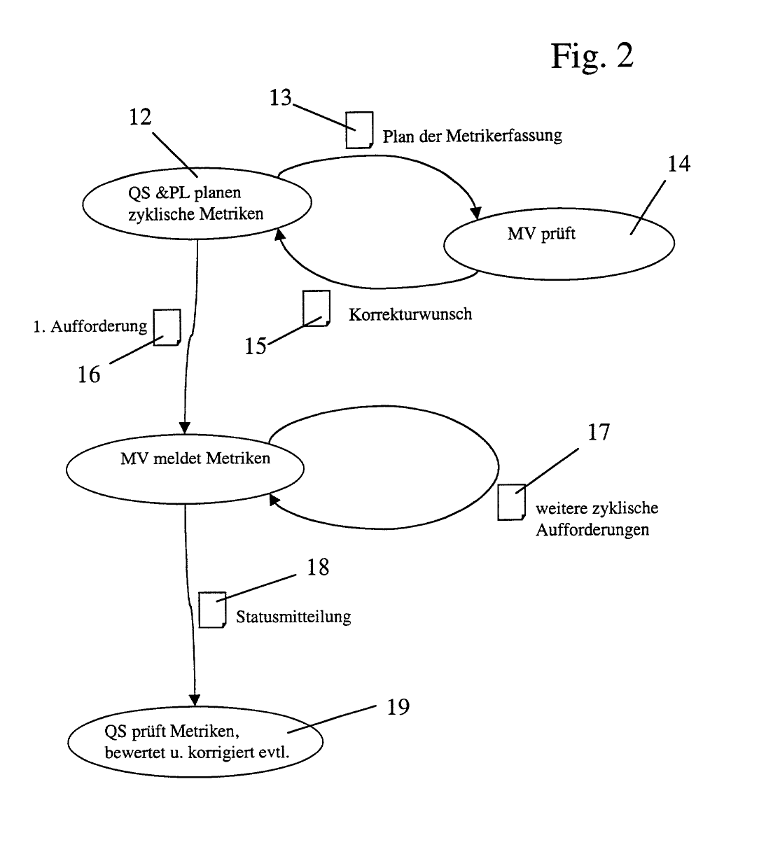

The recording of cyclic metrics, as illustrated in FIG. 2, includes, by way of example, test metrics, in particular test case and error statistics. The recording of a cyclic metric is planned 12 by the quality assurer QA and the project manager PM. This includes associating the type of metric data to be collected with the times, i.e. milestones, of the appropriate functional units and objects in a project, and with the collection cycles, indicated by a start time and the interval for collection. In addition, the person responsible for the metrics MV, the respective project collaborator who is responsible for the individual collections, is named. The person responsible for the metrics MV receives a plan of the metric recording 13 and subjects this plan to a check 14. If appropriate, he/she reports correction requests 15 back to the quality assurer QA and the project manager PL.

After the planning has been completed, the person responsible for the metrics MV receives, at the first recording time by the QMT server, a first request 16 by e-mail containing an explanation and a direct link to the recording mask in the QMT client, the user interface for the project collaborators. The project collaborator can also get to this mask using the entry selection of the QMT client, should he/she have mislaid the e-mail. For cyclic recording, all the data which have been input in the past recording intervals are shown to the project collaborator in read-only form. This is done in tables or else in the form of bar charts, and the new data can be input in obligatory fields, the nominal data item being produced automatically and not being able to be changed, whereas the actual data item is shown for correction.

Should the deadline for recording have been missed by the project collaborator and data not have been input, a default e-mail is sent one day after the recording time. The further cyclic requests 17 have the same properties as the first request 16.

At the end of recording, the person responsible for the metrics MV marks the last recording with an end marker, and the QMT server then sends a status notification 18 to the quality assurer QA. This notification contains a link to the QA monitoring mask in the QMT and permits a final check and assessment. After interviews with the person responsible for the metrics MV, values may need to be adjusted or errors corrected. Should the e-mail have been lost, it is also possible to get the correction mask using the menu guidance in the QMT. Subsequently thereto, the quality assurer QA can display and print numerous parameterizable metric evaluations and reports.

Besides the recording of cyclic metrics, as shown in FIG. 2, it is equally possible to record statistics collected in isolation, such as review metrics, in particular time, quantity and error statistics.

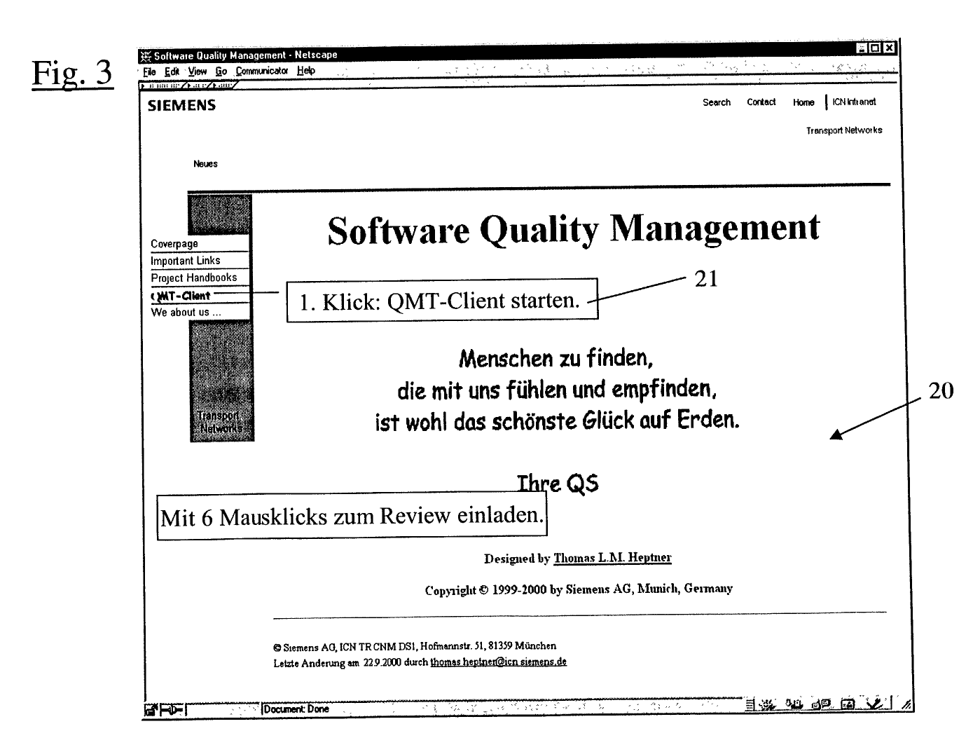

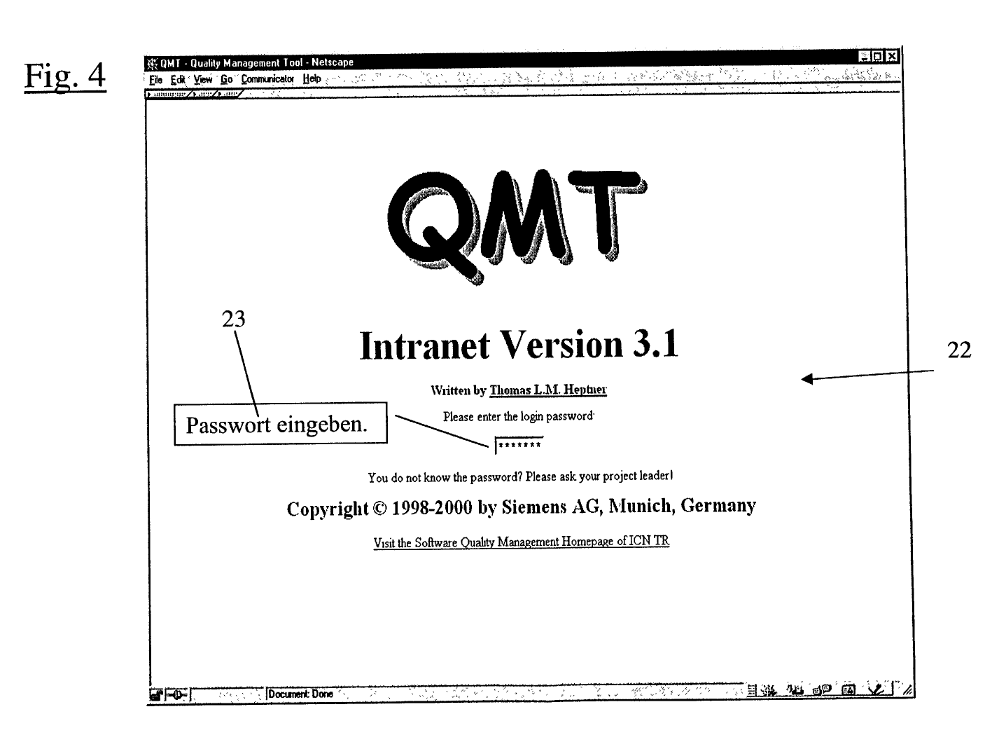

The screenshots shown in FIGS. 3 to 10 are used below to illustrate the invitation to a review. For this purpose, an appropriate link is clicked on the first user interface 20 (shown in FIG. 3) of an intranet in any desired browser; e.g., in Netscape or Explorer. This first click 21 starts a QMT client which is the user interface for the project collaborator. A second user interface 22 (shown in FIG. 4) is then set up in which a password 23 needs to be entered.

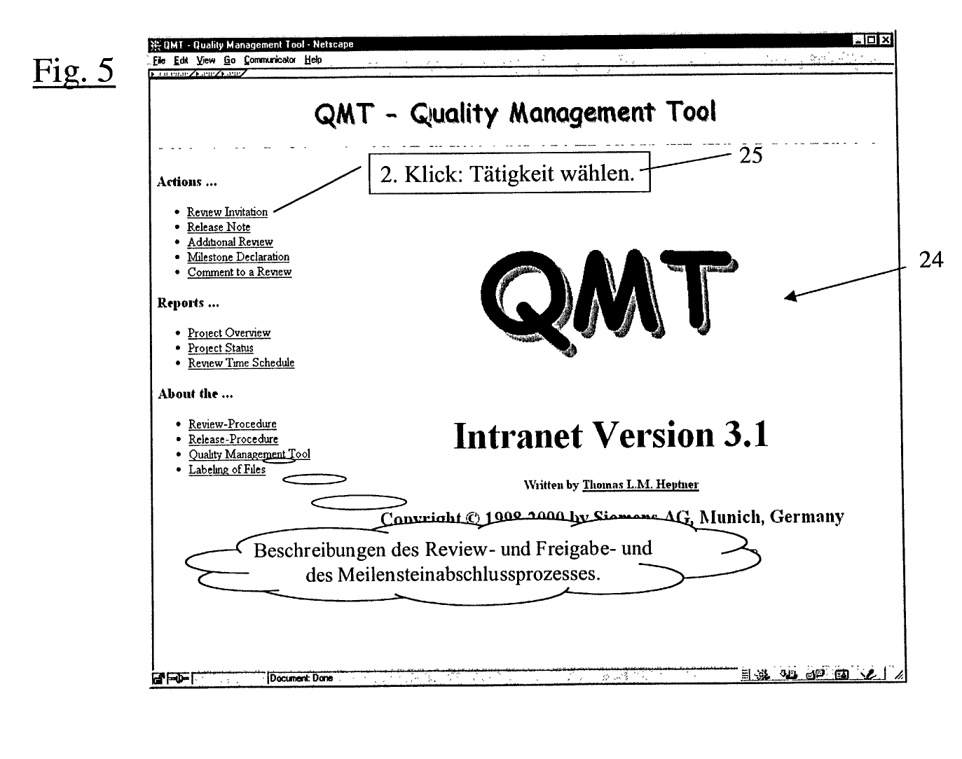

If the password 23 is correct, a third user interface 24 (shown in FIG. 5) is set up in which a second click 25 is used to select the desired actions. In this context, the individual links are combined to form groups of themes. By way of example, the following actions can be selected under the group “actions”: “Invitation to a Review”, “Release Declaration”, “Additional Review”, “Completion of a Milestone” and “Comment on a Review”. The following can be selected under the heading “Reports”: “Project Overview”, “Project Status” and “Review Time Schedule”. In addition, descriptions of the review and release process, of the QMT, of the “Labeling of Files”, of the milestone completion process and of the metric process can be requested online on the user interface.

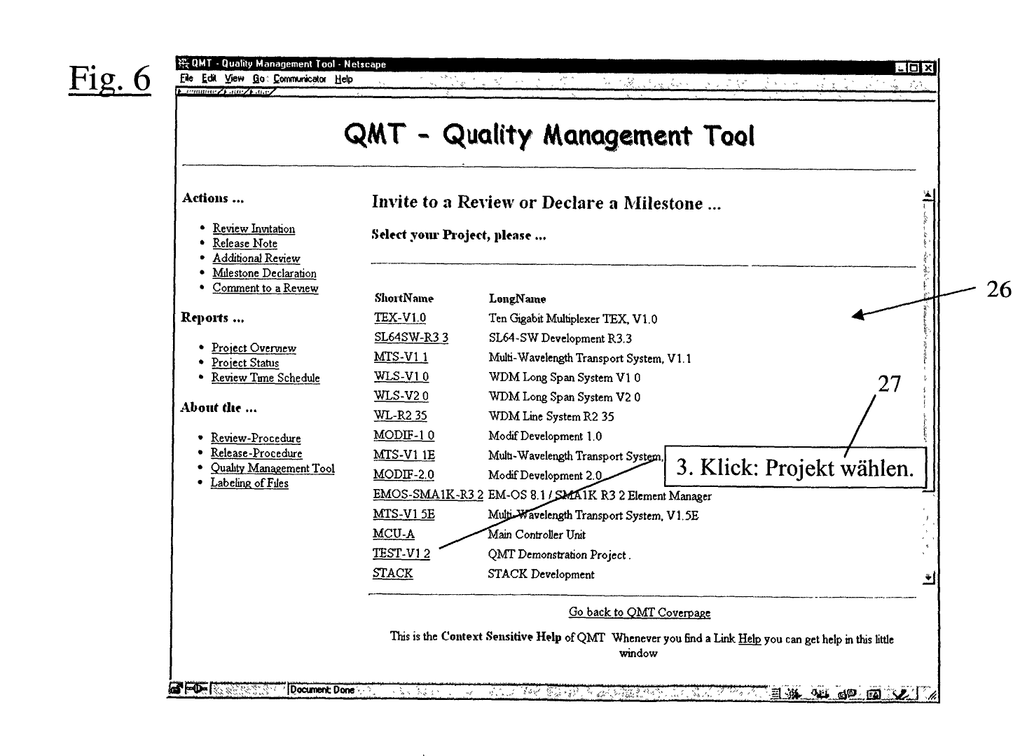

After the second click 25 has been used to select a particular action, in the exemplary embodiment the invitation to a review, a fourth user interface 26 (shown in FIG. 6) is set up. This interface indicates all the currently pending software projects, both with their abbreviated name and with their full name. In addition, context-sensitive help is also possible via a link. This allows the user of the method to obtain relevant and helpful instructions for the respective step which is currently to be performed.

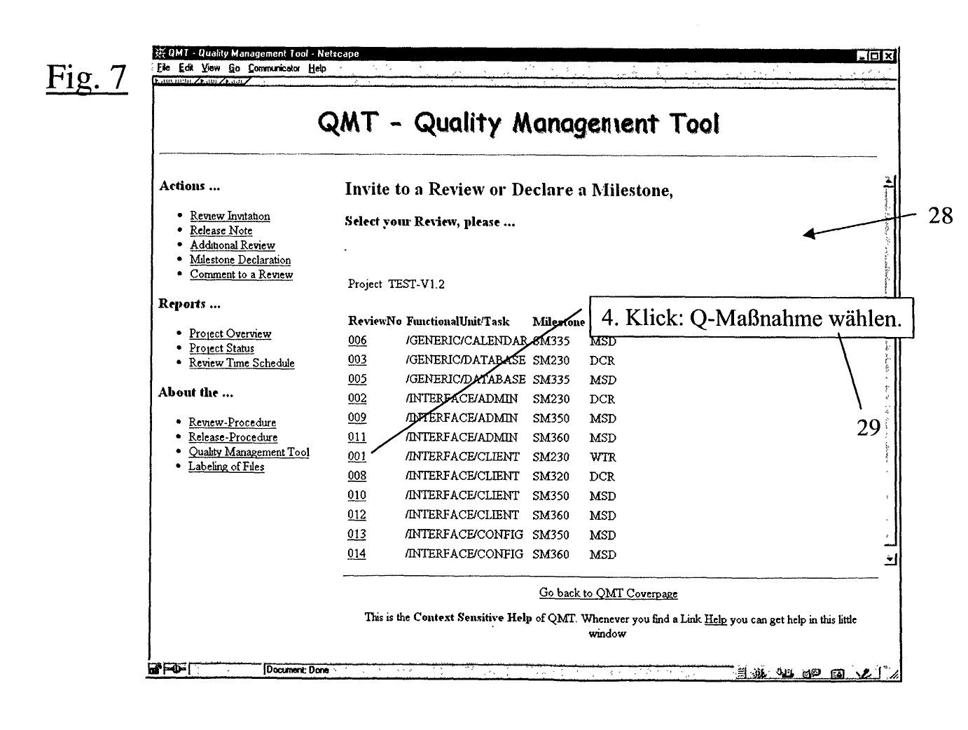

A third click 27 is used to select the project for which the invitation is to be issued. A fifth user interface 28 (shown in FIG. 7) is then set up which contains the details of the selected project. These are the review number, the functional unit, the object, the milestone and also the type of planned review. The user can select the desired quality measure on the basis of object and milestone.

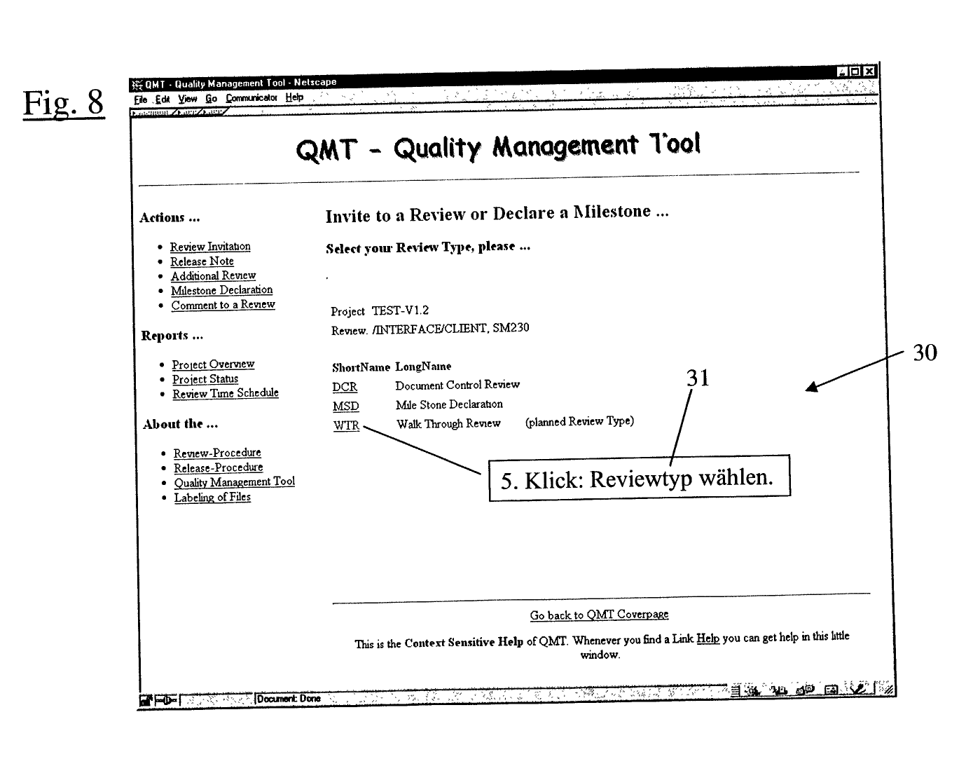

This is done by a fourth click 29 on the appropriate link. A sixth user interface 30 (shown in FIG. 8) is then set up which indicates the abbreviation and also the full name of the review type. These are, by way of example: DCR for Document Control Review, MSD for Milestone Declaration and WTR for Walk Through Review. The invite is thus able to change the type of the quality measure subsequently.

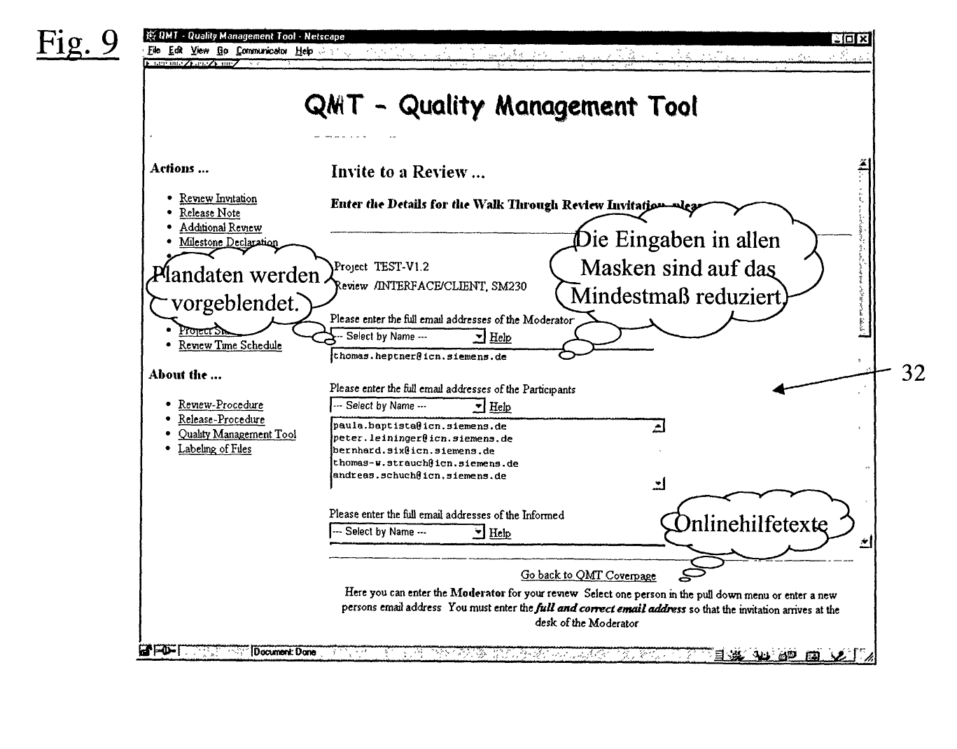

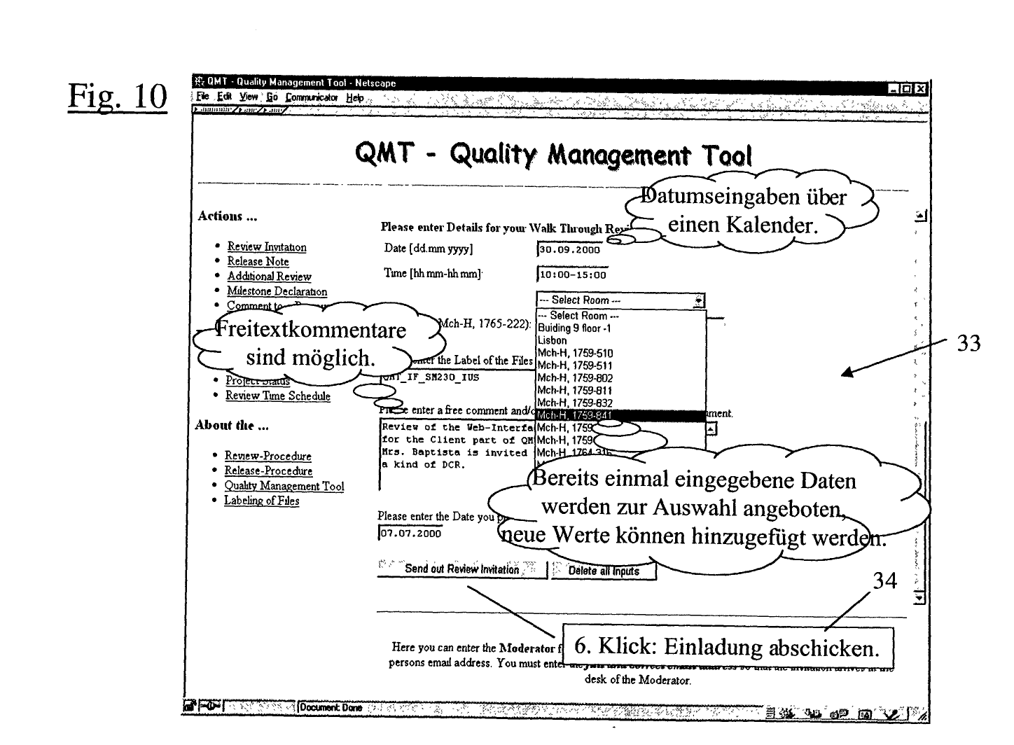

To do this, the invite selects the review type with a fifth click 31. A seventh user interface 32 (shown in FIG. 9) is then set up. In this interface, the user needs to input the e-mail address of the moderator, of the persons involved and of the informed persons in a mask. The inputs are, in this case, reduced to the minimum so that as few errors as possible arise. In this context, it is possible to select the persons from an alphabetically arranged register and to edit them at will merely by clicking on them in each case. In addition, the data item and also the time of the planned review need to be indicated. These can be selected using a calendar for the purposes of simplification. It is likewise possible to use an alphabetically arranged list to select an input for the planned meeting room by clicking on it, and this can be edited at will. In addition, the label of a file can be indicated. The user can input an unspecified text comment in a mask 33, as illustrated in FIG. 10.

A sixth click 34 sends off the invitation to all the relevant persons input in the masks. A confirmation form is provided for printing out.

This simple guidance using links and input masks in which the desired entry can be made simply by clicking guides the user such that it is virtually impossible to make a mistake in operation. This type of user guidance also permits fast quality management, which is associated with little complexity and is accepted by the users due to the process being streamlined and the use of the QMT.

Although the present invention has been described with reference to specific embodiments, those of skill in the art will recognize that changes may be made thereto without departing from the spirit and scope of the invention as set forth in the hereafter appended Claims.

1. A quality management method, implemented by a data processing method, for administering a formal component of a quality assurance process, the method comprising the steps of:
collecting and evaluating cyclic and isolated metrics in arbitrary projects in a computer network having at least one server and a database;
providing client applications for at least one quality assurance client; and
providing separate access rights to project participant clients, the separate access rights respectively obtained via an individual client password.

2. A quality management method as claimed in claim 1, the method further comprising the step of:
using the quality management method for at least one of planning, carrying out, tracking and checking quality assurance processes in arbitrary projects.

3. A quality management method as claimed in claim 1, the method further comprising the step of:
using the method for at least one of planning, collecting, monitoring and evaluating project and process metrics, the project and process metrics being at least one of isolated and cyclic.

4. A quality management method as claimed in claim 1, the method further comprising the steps of:
minimizing inputs to be made by the project participant client;
offering for selection known data which have already been input once; and
showing proposed values to the user wherein the project participant client is able to alter only the data which may be modified without the consent of a quality representative.

5. A quality management method as claimed in claim 1, the method further comprising the step:
producing online in parameterizable form a plurality of at least one of project overviews and metric overviews.

6. A quality management method as claimed in claim 1, the method further comprising the steps of:
producing e-mails automatically by a state-controlled server;
using the e-mails to instigate particular actions in the method;
equipping the e-mails with a direct link to an appropriate recording or input mask; and
sending the e-mails automatically via the state-controlled server in HTML or ASCII format with no attachment.

7. A quality management method as claimed in claim 1, the method further comprising the steps of:
automating fully the method; and
reserving a gap at an end of the automation wherein the quality assurance client may check at least one of the quality of the product, the process implementation and the metrics.

8. A quality management method as claimed in claim 1, the method further comprising the steps of:
enable the quality assurance client to be able to produce, change and delete all data; and
enabling the quality assurance client to be able to initiate or stop actions in the method at any time.

9. A quality management method as claimed in claim 1, wherein the data processing method provides online help.

10. A quality management method as claimed in claim 1, wherein an online method description is available.
